(19) United States
(12) Patent Application Publication
(10) Pub. No.: US 2026/0044880 A1
(43) Pub. Date: Feb. 12, 2026

(54) SYSTEM AND METHOD OF ADAPTING A PROGRAMMATIC ADVERTISING TRANSACTION IN RESPONSE TO CONTENT ANALYSIS

(71) Applicants: Stephen Sivakoff, Dtratford, CT (US); Eamon Wall, Eatontown, NJ (US)

(72) Inventors: Stephen Sivakoff, Dtratford, CT (US); Eamon Wall, Eatontown, NJ (US)

(21) Appl. No.: 19/297,463

(22) Filed: Aug. 12, 2025

Related U.S. Application Data
(60) Provisional application No. 63/681,954, filed on Aug. 12, 2024.
(60) Provisional application No. 63/691,951, filed on Sep. 6, 2024.

(51) Int. Cl. G06Q 30/0251; G06Q 30/0241

(52) U.S. Cl. CPC G06Q 30/0269; G06Q 30/0277

(57) ABSTRACT

Various embodiments comprise systems, methods, architectures, mechanisms, apparatus, or protocols configured to determine whether to present an advertisement contemporaneously with a presentation of user requested content at a user device.

### CROSS-REFERENCE TO RELATED APPLICATION

This application claims the benefit of provisional patent applications Ser. Nos. 63/681,954 filed on Aug. 12, 2024, and 63/691,951 filed on Sep. 6, 2024, which applications are incorporated herein by reference in their entireties.

### FIELD OF THE DISCLOSURE

The present disclosure generally relates to content management systems and, more particularly but not exclusively, to advertising content management systems such as for the automatic placement of advertising assets with content assets such as within a programmatic advertising environment.

### BACKGROUND

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Online publishers typically provide or allocate portions of their web pages for advertising purposes. These areas are sometimes referred to as impression opportunities. Some of the impression opportunities are available for advertising products, services, or businesses not directly provided by or related to the online publishers. In some embodiments, these impression opportunities are available to advertisers for a price. These impression opportunities are sometimes made available directly to advertisers or through one or more advertising networks (sometimes referred to as “ad networks”) operating as middlemen. In some embodiments, advertising exchanges provide a platform for buying and selling advertising impressions by consolidating and managing impression opportunities across a plurality of publishers. Advertisers interested in impression opportunities may comprise an individual, company or other client entity, which may be further represented by one or more advertising agencies. An advertising agency may design and/or implement an advertising campaign on behalf of a client and procure or buy impression opportunities based on the advertising campaign.

Many advertisers would prefer that their ads are not placed on a page to be displayed next to or “against” objectionable content such as might be presented on a webpage being served to a consumer via the consumers client device (e.g., computer, mobile device, tablet and the like). Objectionable content may comprise objectively objectionable content such as jihadi beheading videos and the like or subjectively objectionable content such as negative news stories about an advertiser, content deemed to be immoral or scandalous by the advertiser and so on.

Unfortunately, present programmatic advertising environment technologies do not adequately match advertisements to content against which an advertisement might be presented such as on a webpage provided to a consumer.

### SUMMARY OF THE INVENTION

Various deficiencies in the prior art are addressed by systems, methods, architectures, mechanisms, apparatus or protocols configured to determine whether to present an advertisement contemporaneously with a presentation of user requested content at a user device by processing a retrieved content asset in accordance with a content identification mechanism to generate thereby a content identifier associated with the requested user content, comparing the generated content identifier to one or more lists of content identifiers associated with content categorized as objectionable or non-objectionable in accordance with criteria associated with the proposed advertisement, determining whether to present the advertising in response to the generated content identifier being associated with known objectionable or non-objectionable content, otherwise initiating a text-based correlation process to determine whether to present the advertising in response to a medium confidence correlation of the content to criteria indicative of objectionable or non-objectionable content while continuing the correlation process to achieve a high correlation of the content to criteria indicative of objectionable or non-objectionable such that the content may be included in the appropriate list(s).

In one embodiment, a computer implemented advertisement placement decision apparatus is configured to operatively communicate with equipment within a programmatic advertising system to selectively modify presentation at a user device of advertising assets, the method comprising: a content intake module configured for processing each received content asset to generate a respective content identifier, to categorize the content asset in accordance with medium confidence correlation to each of a plurality of global brand affinity criteria (GBAC), and to store the respective content identifier within a respective hash table of each medium confidence correlated GBAC; and a decision processing module configured for processing each received user requested content asset to generate a respective content identifier, for determining whether the generated content identifier is associated with each of a subset of GBAC hash tables in accordance with target brand affinity criteria (TBAC), and to generate a control signal indicative of whether the user requested content is sufficiently aligned with the TBAC, the control signal being configured to cause a modification of the presentation of an advertising asset to the requesting user. The modification of the presentation of an advertising asset to the requesting user may comprise preventing injection of an advertising content asset into a user presentation stream including the user requested content.

Additional objects, advantages, and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 depicts a simplified block diagram of a system suitable for use in understanding the present invention;

FIG. 2 depicts an exemplary embodiment of a processing module suitable for use in the system of FIG. 1;

FIG. 3 depicts a high-level block diagram of a computing device suitable for use in in the various embodiments;

FIG. 4 depicts a flow diagram of a layered brand safety defense method according to one embodiment;

FIG. 5 depicts a flow diagram of a content processing method according to various embodiments; and

FIG. 6 depicts global content categorization mechanism suitable for use in the content processing methods/systems of the embodiments.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION OF THE INVENTION

The following description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for pedagogical purposes to aid the reader in understanding the principles of the invention and the concepts contributed by the inventor(s) to furthering the art and are to be construed as being without limitation to such specifically recited examples and conditions. Additionally, the term, “or,” as used herein, refers to a non-exclusive or, unless otherwise indicated (e.g., “or else” or “or in the alternative”). Also, the various embodiments described herein are not necessarily mutually exclusive, as some embodiments can be combined with one or more other embodiments to form new embodiments.

The numerous innovative teachings of the present application will be described with reference to the presently preferred exemplary embodiments. However, it should be understood that this class of embodiments provides only a few examples of the many advantageous uses of the innovative teachings herein. In general, statements made in the specification of the present application do not necessarily limit any of the various claimed inventions. Moreover, some statements may apply to some inventive features but not to others. Those skilled in the art and informed by the teachings herein will realize that the invention is also applicable to various other technical areas or embodiments.

Various deficiencies in the prior art are addressed by systems, methods, architectures, mechanisms or apparatus for rapidly analyzing content to gain some indication as to whether or not the content would be objectionable to an advertiser such that the advertiser may determine whether or not to advertise against/adjacent the content (e.g., on the same displayed/presented page viewed by a user).

For example, an advertiser may automatically win an advertisement placement or impression with a demographically appropriate viewer of some webpage the context of a programmatic advertising environment. However, prior to authorizing the placement of the advertisement (e.g., forwarding the URL associated with the advertising asset toward the publisher) the advertiser or some other entity within the programmatic advertising environment may forward toward a trust engine platform, according to one of the embodiments, one or more URLs associated with the content against which the advertisement is to be placed. The trust engine analyzes the content and/or components thereof to extract information categorizing the content in a useful manner such that the advertiser or other entity within the programmatic advertising environment may make a final placement decision as to the advertisement.

The final placement decision may comprise placing the advertisement as originally intended, in which case the URL of the originally intended advertisement is forwarded to the publisher such that the advertising asset may be inserted into the webpage or other content being provided to the user.

The final placement decision may comprise not placing the original advertisement, such as by forwarding to the publisher the URL associated with a blank advertisement asset, an alternate advertisement asset and the like.

The final placement decision may comprise generating a secondary bidding process where the winning advertiser stands in the shoes of the original publisher and attempts to sell to another advertiser the advertisement placement that won in the initial bidding process but no longer wishes to use for itself.

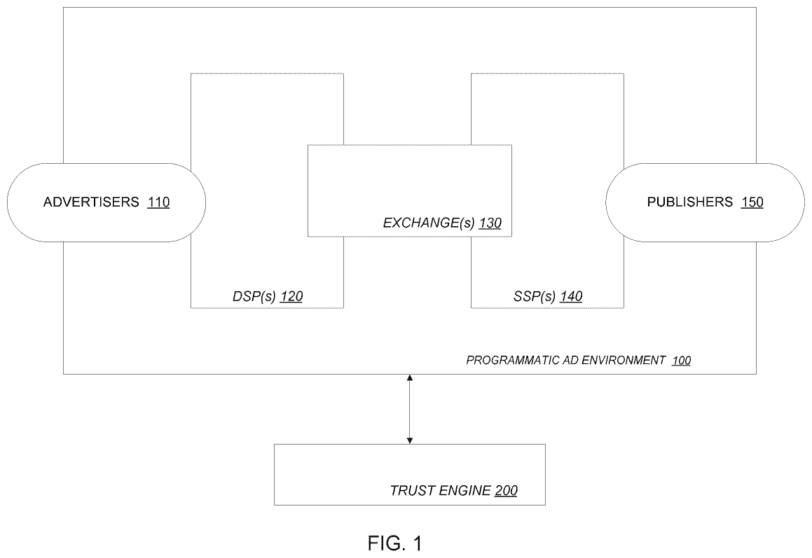

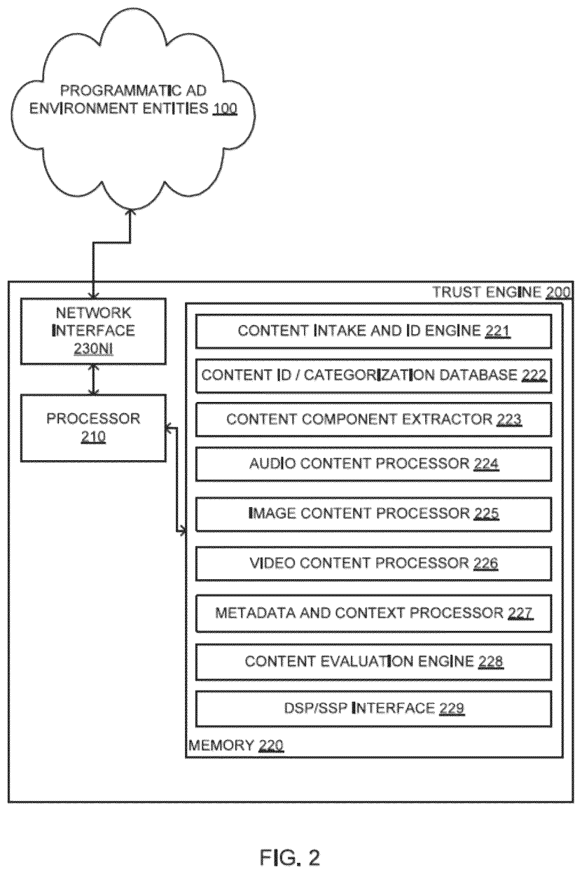

FIG. 1 depicts a simplified block diagram suitable for use in understanding the present invention. In particular, FIG. 1 depicts a programmatic advertising environment 100 in communication with a trust engine 200 such as described below with respect to FIG. 2. It will be appreciated by those skilled in the art that the programmatic advertising environment 100 depicted herein with respect to FIG. 1 merely illustrate some of the most basic functional elements within the programmatic advertisement placement environments in existence today. As such, it will be appreciated by those skilled in the art that numerous other functional elements, entities and the like normally associated with various programmatic advertising environments in existence today are contemplated by the inventor as relevant to the various embodiments though not specifically depicted herein for the sake of simplicity.

The programmatic advertising environment 100 of FIG. 1 is depicted as comprising advertisers 110 in communication with one or more demand side platforms (DSP) 120. FIG. 1 also depicts publishers 150 in communication with one or more supply side platforms (SSP) 140. The DSPs 120 interact with SSPs 140 via one or more exchanges 130 to conduct automated auctions as part of a programmatic advertisement bidding process wherein available placement spots or impression opportunities associated with users/viewers of publisher webpages, apps or other content sources are auctioned to advertisers seeking to place advertisements in front of such viewers/viewers depending upon various criteria, such as the demographic of the user/viewer and so on. The process is fully automated and quickly executed, preferably during the time a webpage is loading or app is retrieving content.

As an example, upon a user landing at a website the publisher identifies the user via previously placed cookies (i.e., small persistent data stored in the user's browser), via a username or via some other tracking mechanism. The publisher's website interacts with the SSP (or perhaps directly) to identify or characterize this user in some way (e.g., age, sex, income or other information accumulated and attachable to this user ID) so that advertisers bidding for advertising placement before such users may bid appropriately. Advertisers are bidding via a demand-side platform interacting with an exchange that cooperates with both the demand-side platform and the supply-side platform. The winning bid is quickly resolved and a URL associated with the advertising asset is normally provided by the DSP or advertiser to the publisher so the publisher can include the advertising asset in the webpage being built or otherwise provided to the user.

Various embodiments contemplate the interruption of the present interaction cycle of one or more entities associated with the programmatic advertisement environment. That is, various embodiments contemplate a need to interrupt the programmatic advertisement placement process to avoid sending an advertising asset URL to the publisher until the advertiser or the advertiser's agency is satisfied that placement of the advertisement against the content to be presented to the user/viewer is appropriate in terms of brand safety, corporate message, brand equity, goodwill or some other criteria.

Therefore, in one embodiment the URL of the proposed content assets is propagated to the trust engine 200 prior to transmitting the URL of advertisement assets to the publisher. The URL of the proposed content assets may be transmitted by the publishers 150, SSPs 140, exchanges 130, DSPs 120, advertisers 110 or any other entity shown or not shown within the programmatic advertising environment 100 such that assembly/delivery of a webpage or other content to a user does not include advertising deleterious to brand safety or other criteria of the advertiser.

After processing content associated with one or more URLs on behalf of a particular advertiser, the trust engine 200 may return information indicating whether or not the content is appropriate to the advertiser, descriptive information about the content, categorization of the content, URLs associated with alternate advertising and/or other information as benefits the advertiser.

FIG. 2 depicts an exemplary trust engine 200. As depicted in FIG. 2, trust engine 200 includes one or more processor(s) 210, a memory 220 and a network interface 230NI. Other functional elements are omitted for simplification of the discussion.

The processor(s) 210 is coupled to each of the memory 220 and the network interface 230NI. The processor(s) 210 is adapted to cooperate with the memory 220, the network interface 230N, and various support circuits (not shown) to perform the trust engine functions as described herein.

The network interface 230NI is adapted to facilitate communications with various network elements, nodes and other entities within the system 100.

The memory 220, generally speaking, stores programs, data, tools and the like that are adapted for use in providing various trust engine/trust management functions which may be invoked by advertisers or other entities within the programmatic advertising environment 100 described above with respect to FIG. 1.

The memory 220 includes various management system programming modules and databases adapted to implement the various trust engine functions described herein.

For example, the memory 220 is depicted as including a content intake and identification engine 221, a content identification and categorization database 222, a content component extractor 223, and audio content processor 224, an image content processor 225, a video content processor 226, a metadata and context processor 227, a content evaluation engine 228 and a DSP/SSP interface 229. Although primarily depicted and described herein with respect to specific functions being performed by invoking the specific functions 221-229, it will be appreciated that the various functions described herein may be combined into larger engines, databases and the like. Various embodiments, all of the specific functions 221-229 are combined into an overall content processing function. The following description will primarily focus on such an overall content processing function, with some identification of specific functions/tasks indicated therein.

The content intake and identification engine 221 is configured to receive content related URLs from entities within the programmatic advertising environment 100 and identify the associated content. Generally speaking, the content intake and identification engine 221 receives the URL of the content assets to be published prior to assembly/delivery of the webpage (or app imagery) to the user. The content assets may include still or moving imagery, audio, text and so on including metadata and other information such as packet header information, address information, data structure identification information and the like.

With the content asset URL, the trust engine 200 retrieves the relevant content and subjects the retrieved content to various content analysis techniques to determine whether advertising placement against the content is appropriate. In various embodiments, content analysis comprises a hierarchy of content analysis techniques constructed to rapidly yield a decision as to place and were not placing an advertisement against that content. Trust engine processing may comprise one of a number of techniques, such as blacklisting and whitelisting publishers, content sources and the like. Processing may also include using text, metadata and/or other information to identify context associated with still or moving image content, such as examining header information within the image packets, related image synopsis or identification information associated with the image and so on.

Content identification may be performed in accordance with third-party tools such the photo DNA tools or processes such as those currently used to identify highly objectionable content such as still and video images depicting child pornography and the like. Briefly, such tools comprise a database listing “fingerprints” of pictures or videos of such highly objectionable content which were previously extracted in accordance with various processes which generate a unique identifier or “fingerprint” of a picture or video. Thus, in some embodiments, the content intake and identification engine 221 utilizes a predefined content identification mechanism or process each still or moving image associated with a received content related URL to extract therefrom such a unique identifier or “fingerprint” which is then compared to identifiers associated with known objectionable content. A database of identifiers associated with such known objectionable content may be included within the content ID/categorization database 222 and or included within a local or remote third-party database (not shown) accessed via the trust engine 200.

### Whitelist/Blacklist

For example, a quick positive decision regarding placement may be reached if the publisher is part of a whitelist of known good publishers such that all of the content these publishers will present to users is deemed to be acceptable to the brand. Similarly, a quick negative decision may be reach of the publisher as part of a blacklist of known bad publishers such that none of the content these publishers were present to users is deemed to be acceptable to the brand. This whitelist/blacklist processing may be performed as part of the initial transaction such that no further processing is necessary by the trust engine to get to a placement decision. Other brand safety decisions may be included within existing exchanges such that there is no need for trust engine processing of certain programmatic advertising placement transactions.

### Extracting and Comparing Content Fingerprints

Photo DNA and eGLYPH technologies (such as provided by Hany Farid) provide a computationally efficient mechanism to identify whether a particular image or video has previously been flagged as obscene or inappropriate in some way. The photo DNA technologies have been applied to child pornography wherein each new or unknown image is automatically processed to extract a unique identifier as well as manually screened and associated with the ranking such as acceptable, obscene but not involving children, obscene involving children or whatever. A hash table is built using the identifiers of all images determined to be obscene involving children. The hash table is then used to process images received by any domain or publisher.

Briefly stated, any new image received by a domain or publisher is automatically processed to extra the unique identifier of the new image, which identifier is then pushed into the hash table to see if it matches that of an image previously identified as obscene involving children (in this example). If the identifier of the new image matches anything in the hash table than the new image is simply dropped from the domain or publisher. As a secondary matter the source of the image may also be forwarded to law enforcement etc. This type of processing is legally acceptable since obscenity involving children is not protected speech and can therefore be discarded. This type of content also violates the terms of service of virtually any domain or publisher or website.

The eGLYPH technology operates in a manner similar to that of the photo DNA technology, except the eGLYPH technology is directed towards video imagery. I expect that the specific content identification or fingerprinting techniques are a little bit different but built along the same lines as photo DNA. I also expect that there is manual processing of video imagery contemplated with respect to the eGLYPH technology. As such, the eGLYPH technology may be used to process video imagery in the same way as the photo DNA technology processes still imagery.

Within the context of child pornography and the like, photo DNA and eGLYPH technologies operate to prevent such imagery from being circulated within a domain or publisher or website.

Content identification/categorization database 222 is used to store content identification information, content categorization information and so on as described herein. Several types of content categories are contemplated as being relevant to some or all advertisers.

### Universally Bad Categories

Various embodiments utilize photo DNA, eGLYPH and/or other technologies to uniquely identify still and moving imagery in accordance with various categories consistent with the categories of concern to the various brands. One category might comprise extremist videos or pictures, extremist messages or postings and so on. Another category might comprise kittens. Another category might comprise right-wing political movements such as Nazis are alt-right trite/white supremacy movements. Another category might simply comprise violence above some threshold level (kind of an MPAA rating of PG-13, X and the like). There are a number of different categories that are contemplated.

### Brand Specific Categories

In addition to general categories as mentioned above, there are also brand specific categories to be identified. These types or categories can be built or identified on the fly in all likelihood. For example, United airlines probably does not wish to advertise next to content describing flight attendants beating the crap out of somebody on the plane. The news story describing such an incident may be readily discerned by analyzing the text associated with that news story. No need to analyze still or moving imagery make this decision.

### The 200 ms Loop and the Limits of Photo DNA

Generally speaking, the time between a user clicking on a link associated with a webpage and the execution of a relevant programmatic advertisement placement is about 200 ms. That is, as the webpage is being loaded in the user's browser and presented to the user via whatever display device (phone display, computer display etc.) the automated bidding and placement process is executed such that the relevant advertisements are loaded contemporaneously with or shortly after the content is loaded such that the content and advertising assets are displayed together (i.e., adjacent with each other). There may also be further processing in terms of adapting the placed advertisement such as to the formatting of the content such that it blends seamlessly from an aesthetic perspective.

Trust engine processing inevitably adds some processing time to the loop, such as time to extract still or moving imagery identification information (e.g., digital “fingerprints”) from the proposed content to be displayed adjacent to the advertising.

If the proposed content has already been processed via photo DNA or eGLYPH manual screening and deemed to be unsafe then various embodiments contemplate hashing the extracted imagery fingerprint with the “unsafe content hash table” in immediately identifying the content as unsafe and proceeding accordingly (e.g., place a backup or secondary advertisements, place new advertisement or whatever).

If the proposed content has already been processed via photo DNA or eGLYPH manual screening and deemed to be safe, then when the extracted imagery fingerprint is hashed with the “safe content hash table” the trust engine will immediately identify the content as safe and proceed accordingly. To conserve computational/memory resources, various embodiments avoid the use of a single or global “safe content hash table” and instead utilize/generate numerous safe content hash tables based upon information such as content source and the like. In various embodiments, a single safe content hash table is generated/utilized for each publisher or advertiser, which hash table is augmented over time as additional content from the publisher or advertiser is processed.

It may be the case that a number of ads are placed against/adjacent unsafe content due to a time lag in determining what content is safe or not. This may be acceptable and in fact may be inevitable given the limits of processing power and speed and so on. The point is to minimize the number of subjectively unsafe brand placements and minimize a number as rapidly as possible. Therefore, various embodiments optionally provide for manual processing of content from at least some sources, such as sources that are associated with non-preferred or blacklisted sources for example. Various embodiments utilize a combination of manual processing of content and automatic processing of content. Various embodiments utilize automatic processing of content alone.

### Multiple Hash Tables

Various embodiments utilize multiple hash tables to augment existing highly objectionable content hash tables such as use with the photo DNA technologies, databases and the like. That is, various embodiments extract image fingerprints from all content being manually or automatically processed, whether such content is deemed to be objectionable or not ultimately. Upon categorization of content the image fingerprint associated with the content is hashed into one or more category specific hash tables or databases such as “objectionable” content, “safe” content, “rated X” content, “rated PG-13” content, “political” content, “violent” content, “religious” content and so on. In this manner, subsequent retrieved content such as still or moving images may be processed against multiple hash tables or databases to more rapidly categorize the subsequently retrieved content and thereby speed up the advertising placement/no placement decision process.

In various embodiments, trust engine processing is contemporaneous with, and supplemental to, the existing processing performed on behalf of anti-child pornography and anti-extremist efforts.

In various embodiments, trust engine processing resulting in data relevant to anti-child pornography and anti-extremist efforts may be provided to organizations associated with such efforts for the benefit of all advertisers.

Various embodiments contemplate categorizing content in a manner useful to individual brands in real time or substantially real time, depending upon the type of content, the amount of content to be processed and so on. As previous noted, such content categorizing builds existing databases such as category related databases which in turn improves subsequent processing of received content. As an example, a user downloading a webpage will be one of thousands or millions of users ultimately downloading the same or similar webpage. Once the content associated with that webpage his process, the relevant databases are updated to reflect this processing. As such, the trust engine will preferably perform first impression processing of content only once. The trust engine may perform subsequent processing of first impression processed content to improve categorization of that content where the likelihood of additional access of the content by demographically relevant users is high such that the effort is justified.

In various embodiments, if proposed content has never been processed via photo DNA or eGLYPH manual screening then trust engine 100 may perform first impression processing of the content. This may be performed in a cursory or sampling manner or a detailed manner, depending upon time constraints and the like.

Thus, in various embodiments, content component extractor 223 operates to extract and/or sample content indicated via a received URL. For example, content component extractor 223 may extract an audio track from video content, one or more images from video content, one or more portions of an image from still or moving imagery and so on. In addition to content component extraction, metadata and other data may also be extracted by content component extractor 223 in various embodiments.

In various embodiments, content processing AI tools are utilized to perform automated content analysis and categorization of the proposed content.

Various embodiments contemplate an ability to broadly categorize content as acceptable or not using a sequent of applied techniques.

Various embodiments, audio content processor 224 performs analysis of audio information associated with an audio track of a video stream or audio content. For example, such audio information may be processed using speech to text processing followed by context, keyword identification and other processing techniques to identify whether or not the content is brand safe. Extracted audio information may also be subjected to language analysis to enable automated text extraction in the relevant language. For example, objectionable videos may be determined by identifying the native language of the relevant audio track, performing speech to text processing to provide thereby native language text, converting the native language text into English text and then performing keyword analysis, context analysis and so on to get some sense as to whether or not the video contains unwanted content. In one embodiment, identification of the language may be enough. For example, an advertisement to be served against content of a particular language to someone who does not speak that language may, according to some advertiser criteria, be sufficient to determine that placement of the advertisement with this content is not appropriate.

In various embodiments the trust engine extracts metadata from the content such as thumbnail imagery or other imagery/data carried in the header or other locations within the content packet stream for subsequent processing. Various embodiments the trust engine samples video imagery to provide a small but representative number of still images to process.

In various embodiments the trust engine uses existing image matching tool such as those provided by Google to identify specific images or at least images similar to e proposed image. For example, if a still image or a number of images extracted from a video stream are deemed by the Google matching tool or any other tool as similar to unwanted content then the trust engine may in some instances deem the proposed content to be objectionable content such that no advertising placement is appropriate.

In various embodiments the trust engine uses an image comparison tool to identify a number of potentially identical or relevant images, extracts from these images and the available metadata text or contextual information and analyzes the extracted metadata text or contextual information to determine whether imposed content is objectionable content such that no advertising placement is appropriate.

In various embodiments, a cache is used to store content or components thereof during processing. These embodiments content may be fully processed according to multiple techniques to derive content identification fingerprints, content categorization, context information associated with related information and so on. When sufficient information to determine whether or not the content or content component is appropriate for brand safety purposes, a URL may be provided to the programmatic advertising environment 100 indicative of the primary advertisement to be placed, a secondary advertisement he placed, a blank advertisement and the like. It is noted that the cache content may be further processed to extract therefrom additional categorization information and the like useful in performing future content processing operations. Thus, the content/content component cache operates to store content or links thereto as part of a comprehensive content processing methodology in which a hierarchical arrangement of content processing techniques are deployed in execution speed rank order such that a relatively fast placement/non-placement decision may be made by the advertiser as sufficient information is determined.

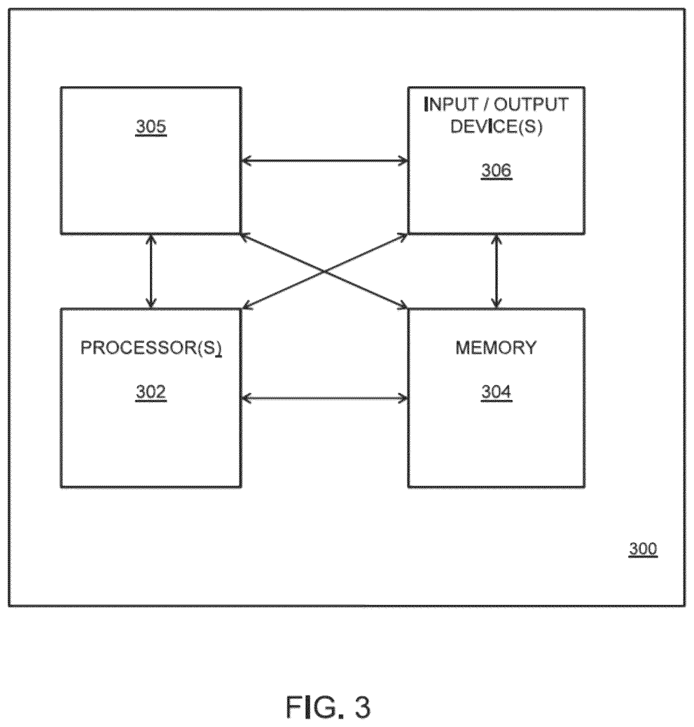

FIG. 3 depicts a high-level block diagram of a computing device, such as a processor in a communications network element, suitable for use in performing functions described herein such as those associated with the various elements described herein with respect to the figures.

In particular, any of the various functional entities described herein, such as network routing entities, network management entities, server devices, client devices and so on within the communication network may be implemented in accordance with a general computing device structure such as described herein with respect to FIG. 3.

As depicted in FIG. 3, computing device 300 includes a processor element 303 (e.g., a central processing unit (CPU) or other suitable processor(s)), a memory 304 (e.g., random access memory (RAM), read only memory (ROM), and the like), a cooperating module/process 305, and various input/output devices 306 (e.g., a user input device (such as a keyboard, a keypad, a mouse, and the like), a user output device (such as a display, a speaker, and the like), an input port, an output port, a receiver, a transmitter, and storage devices (e.g., a persistent solid state drive, a hard disk drive, a compact disk drive, and the like)).

It will be appreciated that the functions depicted and described herein may be implemented in hardware or in a combination of software and hardware, e.g., using a general purpose computer, one or more application specific integrated circuits (ASIC), or any other hardware equivalents. In one embodiment, the cooperating process 305 can be loaded into memory 304 and executed by processor 303 to implement the functions as discussed herein. Thus, cooperating process 305 (including associated data structures) can be stored on a computer readable storage medium, e.g., RAM memory, magnetic or optical drive or diskette, and the like.

It will be appreciated that computing device 300 depicted in FIG. 3 provides a general architecture and functionality suitable for implementing functional elements described herein or portions of the functional elements described herein.

It is contemplated that some of the steps discussed herein may be implemented within hardware, for example, as circuitry that cooperates with the processor to perform various method steps. Portions of the functions/elements described herein may be implemented as a computer program product wherein computer instructions, when processed by a computing device, adapt the operation of the computing device such that the methods or techniques described herein are invoked or otherwise provided. Instructions for invoking the inventive methods may be stored in tangible and non-transitory computer readable medium such as fixed or removable media or memory or stored within a memory within a computing device operating according to the instructions.

Although primarily depicted and described as having specific types and arrangements of components, it will be appreciated that any other suitable types and/or arrangements of components may be used for elements described herein and/or any portions thereof. These elements or portions thereof may be implemented via computing devices of various types, though generally a processor element (e.g., a central processing unit (CPU) or other suitable processor(s)), a memory (e.g., random access memory (RAM), read only memory (ROM), and the like), various communications interfaces (e.g., more interfaces enabling communications via different networks/RATs), input/output interfaces (e.g., GUI delivery mechanism, user input reception mechanism, web portal interacting with remote workstations and so on) and the like.

For example, various embodiments are implemented using computing and/or networking equipment used to implement various functions, the equipment comprising processing resources (e.g., one or more servers, processors and/or virtualized processing elements or compute resources) and non-transitory memory resources (e.g., one or more storage devices, memories and/or virtualized memory elements or storage resources), wherein the processing resources are configured to execute software instructions stored in the non-transitory memory resources to implement thereby the various methods and processes described herein. The computing and/or networking equipment may also be used to provide some or all of the various other core network nodes or functions described herein.

As such, the various functions depicted and described herein may be implemented at the elements or portions thereof as hardware or a combination of software and hardware, such as by using a general purpose computer, one or more application specific integrated circuits (ASIC), or any other hardware equivalents or combinations thereof. In various embodiments, computer instructions associated with a function of an element or portion thereof are loaded into a respective memory and executed by a respective processor to implement the respective functions as discussed herein. Thus, various functions, elements and/or modules described herein, or portions thereof, may be implemented as a computer program product wherein computer instructions, when processed by a computing device, adapt the operation of the computing device such that the methods or techniques described herein are invoked or otherwise provided. Instructions for invoking the inventive methods may be stored in tangible and non-transitory computer readable medium such as fixed or removable media or memory or stored within a memory within a computing device operating according to the instructions.

Various modifications may be made to the systems, methods, apparatus, mechanisms, techniques and portions thereof described herein with respect to the various figures, such modifications being contemplated as being within the scope of the invention. For example, while a specific order of steps or arrangement of functional elements is presented in the various embodiments described herein, various other orders/arrangements of steps or functional elements may be utilized within the context of the various embodiments. Further, while modifications to embodiments may be discussed individually, various embodiments may use multiple modifications contemporaneously or in sequence, compound modifications and the like.

### Layered Brand Safety Defense

The various embodiments discussed above contemplate a layered defense approach to brand safety within the context of programmatic advertising. Different defensive layers supporting brand safety may be implemented via a local brand safety platform, via remote platforms or by some combination of local and remote platforms.

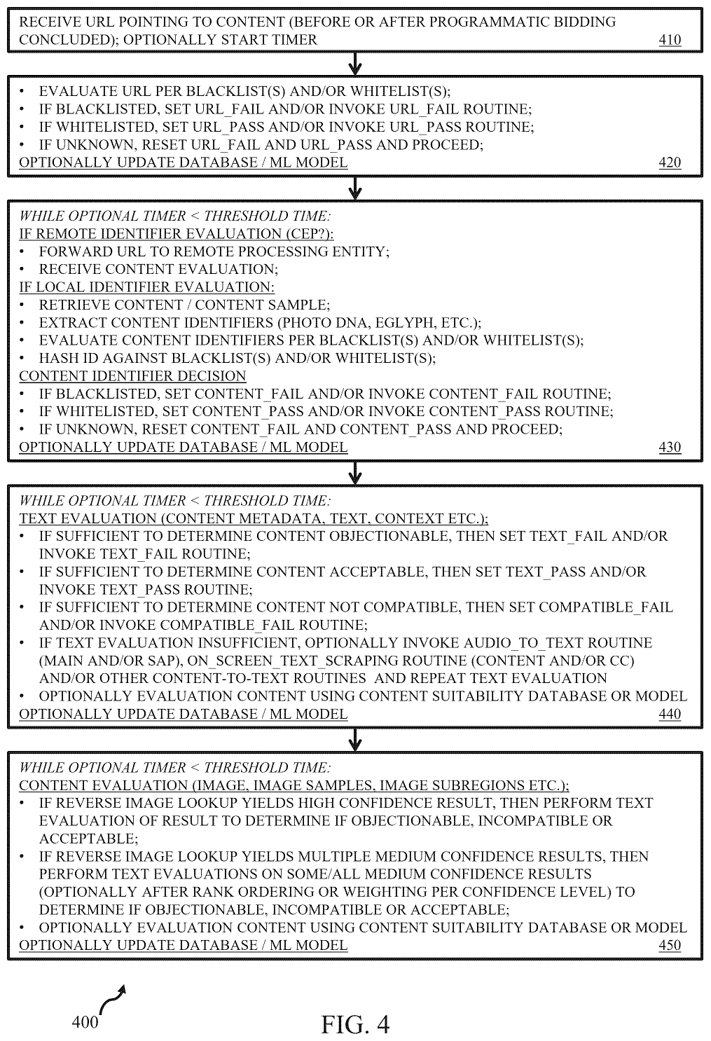

FIG. 4 depicts a flow diagram of a layered brand safety defense method according to one embodiment. Various modifications to this method are contemplated by the inventors including different orders of the elements, a mix of remote and local processing of content or content related information and so on. Various steps and/or portions thereof of the method 400 of FIG. 4 may be performed by the trust engine 200 described above with respect to FIG. 2 either alone or in conjunction with other entities interacting with the trust engine 200.

At step 410, a uniform resource locator (URL) pointing to content is received by the brand safety platform. Typically, this URL will be received after the successful conclusion of a programmatic bidding process in which the advertiser utilizing the brand safety platform has won the right to present an advertisement to a user in conjunction with the presentation of the content to the user. In various embodiments, the URL is received before or even during the programmatic bidding process but that the processing steps described herein and elsewhere in this specification may begin as quickly as possible.

Optionally, at step 410 a timer is started. Within the context of the method 400 of FIG. 4 the timer represents an amount of time elapsed after conclusion (or start) of a programmatic bidding process. In some embodiments, if a certain amount of time has elapsed been a default decision or decision based upon the then best estimate is provided.

For example, if anything more than a several hundred millisecond, one second, five seconds or some other threshold time has elapsed, then the method 400 may exit and provide to the SSP a URL pointing to a default one of the primary, secondary, tertiary or blank advertisement. If sufficient processing has occurred to indicate that the content is likely not universally objectionable, then a URL pointing to primary advertisement may be provided. If sufficient processing has occurred to indicate that the content may be objectionable with respect to brand image, then a URL pointing to a secondary or tertiary advertisement may be provided. Other decisions may also be made based upon the circumstances and related circumstances as will be appreciated by those skilled in the art.

### Content URL Processing

At step 420, an evaluation of the URL itself is performed. That is, at step 420 and evaluation of the website pointed to by the URL, any metadata or text associated with the URL and so on is evaluated such as by comparing the URL or related metadata or text to one or more blacklists and or one or more white lists.

If the blacklist comparison indicates that the URL is blacklisted then a URL_fail flag may be set and/or a URL_fail routine may be invoked. Either of these mechanisms may be used to trigger a decision to not place primary advertising next to the content to be displayed to the user (or to place secondary or tertiary advertising next to the content to be displayed to the user).

If the whitelist comparison indicates that the URL is whitelisted then a URL_pass flag may be set and/or a URL_pass routine may be invoked. Either of these mechanisms may be used to trigger a decision to place primary advertising next to the content to be displayed to the user.

In some embodiments, an affirmative comparison of either blacklisting or whitelisting of content associated with the URL is dispositive in terms of the decision to place or not place primary advertising next to the content to be displayed to the user. In some embodiments, an affirmative comparison of one or both of blacklisting or whitelisting of content associated with the URL is not by itself dispositive; rather, this information is used in conjunction with subsequently determined information to make a decision about whether or not to place primary advertising next to the content to be displayed to the user. In this case the setting or resetting the various flags provide a mechanism by which blacklist/whitelist affirmative comparison results may be propagated to subsequent processing elements/routines within the brand safety platform.

Optionally at step 420, if the result of the blacklisting and whitelisting comparisons is inconclusive, the URL_fail and/or URL_pass flags may be reset and the method 400 may proceed.

### Content Identification Processing

At step 430, an evaluation of the photo DNA, eGLYPH or other content identifier associated with the content indicated by the URL is performed. Such evaluation is optionally performed while the optional timer remains less than a threshold amount of time.

If remote evaluation of the content identifier is used, then the URL is forwarded to a remote processing entity such as provided by Counter Extremism Project (CEP) for further processing such as described at the CEP website at www.counterextremism.com. Other third-party entities may also be used to perform this function, which function will ultimately result in receiving an evaluation of the content identified by the URL.

If local evaluation of the content identifier is used, then the content or a sample of the content is retrieved via the URL. Content identifiers are then extracted from the retrieved content or portion thereof such as in accordance with the photo DNA, eGLYPH or other processes to produce a unique content identifier or “fingerprint” associated with the content proposed to be presented to a user in conjunction with the primary advertisement. Generally speaking, extracting content identification information rapidly provides a unique mechanism by which the content may be identified.

In various embodiments, the extracted content identification information is hashed into one or more blacklists hash tables and or one or more white list hash tables to determine whether or not the content matches content previously determined to be universally objectionable, brand safety objectionable or appropriate. The various blacklist and/or whitelist hash tables may be stored locally or remotely. The various blacklist and/or whitelist hash tables may be shared with other entities as content related information is determined by the brand safety platform.

If the blacklist comparison indicates that the extracted content identification information matches that of previously blacklisted content then a CONTENT_fail flag may be set and/or a CONTENT_fail routine may be invoked. Either of these mechanisms may be used to trigger a decision to not place primary advertising next to the content to be displayed to the user (or to place secondary or tertiary advertising next to the content to be displayed to the user).

If the whitelist comparison indicates that the extracted content identification information matches that of a previously whitelisted content then a CONTENT_pass flag may be set and/or a CONTENT_pass routine may be invoked. Either of these mechanisms may be used to trigger a decision to place primary advertising next to the content to be displayed to the user.

In some embodiments, an affirmative comparison of either blacklisting or whitelisting of content associated with the content identification information is dispositive in terms of the decision to place or not place primary advertising next to the content to be displayed to the user. In some embodiments, an affirmative comparison of one or both of blacklisting or whitelisting of content matching the content of notification information is not by itself dispositive; rather, this information is used in conjunction with subsequently determined information to make a decision about whether or not to place primary advertising next to the content to be displayed to the user. In this case the setting or resetting the various flags provide a mechanism by which blacklist/whitelist affirmative comparison results may be propagated to subsequent processing elements/routines within the brand safety platform.

Optionally at step 430, if the result of the blacklisting and whitelisting comparisons is inconclusive, the CONTENT_fail and/or CONTENT_pass flags may be reset and the method 400 may proceed.

### Content Text Processing

At step 440, an evaluation of the text associated with the content to be displayed to the user is evaluated, such as metadata, content text, descriptive text, surrounding article text and other contextual information associated with the content. Such evaluation is optionally performed while the optional timer remains less than a threshold amount of time.

Evaluation of text associated with the content may definitively produce a result sufficient to determine that the content is universally objectionable, incompatible with the brand or appropriate for the brand. This evaluation may be performed using keyword searching, associative strength analysis, link strength analysis and/or any number of correlation techniques. Ultimately content text processing is intended to identify with some level of confidence whether or not the content itself (i.e., the still or moving imagery) is appropriate for display in conjunction with the advertising. Differencing engines, neural networks, brute force computing techniques and the like are all suitable for use in performing this task though processing power, memory and time constraints of selected processing mechanisms may lead to inexact though useful/actionable results.

If the text evaluation mechanisms are sufficient to determine that the content is objectionable, then a TEXT_fail flag may be set and/or a TEXT_fail routine may be invoked. Either of these mechanisms may be used to trigger a decision to not place primary advertising next to the content to be displayed to the user (or to place secondary or tertiary advertising next to the content to be displayed to the user).

If the text evaluation mechanisms are sufficient to determine that the content is acceptable, then a TEXT_pass flag may be set and/or a TEXT_pass routine may be invoked. Either of these mechanisms may be used to trigger a decision to place primary advertising next to the content to be displayed to the user.

If the text evaluation mechanisms are sufficient to determine that the content is compatible with brand safety, then a COMPATIBLE_pass flag may be set and/or a COMPATIBLE_pass routine may be invoked. Either of these mechanisms may be used to trigger a decision to place secondary or tertiary advertising next to the content to be displayed to the user.

If the text evaluation mechanisms are unable to determine that the content is universally objectionable, compatible or incompatible with brand safety, then additional processing may be invoked to generate more text-based information to be processed. Specifically, various embodiments contemplate the use of one or more mechanisms to derived additional text-based information pertaining to the content to be displayed to the user, wherein such mechanisms may be invoked locally or remotely such as via a third party provider services.

In various embodiments, additional text-based information associated with the content is derived by processing the audio information associated with the content. That is, in various embodiments audio to text processing may be performed to extracted text from audio information of a primary or separate audio program (SAP) associated with the content. This additional text-based information associated with the content may then be processed using one or more text evaluation mechanisms such as described above.

In various embodiments, additional text-based information associated with the content is derived by on screen text scraping of the still or moving imagery of the content. That is, in various embodiments text identification techniques may be used to identify those portions of still or moving imagery associated with text such as screen scrolls, closed captions and so on such that these portions may be extracted or “scraped” from the imagery and subjected to optical character recognition (OCR) techniques to derive therefrom additional text-based information associated with the content. This additional text-based information associated with the content may then be processed using one or more text evaluation mechanisms such as described above.

### Content Processing

At step 450, an evaluation is performed of the still or moving imagery, or samples, subsamples, image regions and the like thereof associated with the content. Such evaluation is optionally performed while the optional timer remains less than a threshold amount of time.

In various embodiments, a local or remotely accessed reverse image look up service is used to process images information associated with the content to be displayed to the user. In various embodiments the reverse image look up service provides descriptive information associated with the content sufficient to enable a determination as to whether or not the content is universally objectionable, brand incompatible or brand acceptable. The descriptive information may include a confidence indicator suitable for assigning a weight to the descriptive information in determining whether to display primary, secondary or no advertising alongside the content to be displayed to the user.

In various embodiments, the reverse image look up service provides potential identical or similar images (or URL pointers thereto) to that of the content to be displayed to the user.

In various embodiments, the potential identical or similar images may be further processed according to any of steps 420-450 to generate additional information suitable for use in determining whether or not to place advertisements with the content to be presented to the user. For example, if video content to be displayed to the user is identical or similar to that of video content provided by blacklisted sites then an inference may be made that the content to be this way to the user is also objectionable. Similarly, metadata, text or contextual information associated with the “identical or similar” video content to be processed as described with respect to step 440 to render a decision.

In various embodiments, reverse image look up services will provide multiple medium confidence results rather than a single high confidence results. In these embodiments, the medium confidence results may be evaluated to render an advertisement placement decision with respect to the content to be presented to the user. In various embodiments, multiple medium confidence images/results may be further processed according to any of steps 420-450 to generate additional information suitable for use in determining whether or not to place advertisements with the content to be presented to the user.

In various embodiments, the medium confidence results are ranked in order of confidence level and/or other criteria and processed as described above. In various embodiments, a correlation process is initiated to provide text-based correlations between text extracted from user requested content assets and text associated with proposed advertisements (e.g., brand-related, advertiser related and the like). Place or don't place decisions may be made in response to medium confidence correlations (e.g., between 40% and 60% for example) while continued correlation processing may ultimately yield a high confidence correlation (e.g., above 60% or 70% for example).

The various processing steps described herein with respect to FIG. 4 such as URL evaluation, text evaluation and content evaluation may be performed in conjunction with a programmatic advertisement transacting platform or portion thereof. The various processing steps utilized hash tables and databases and the like which over time build a valuable archive of information suitable for streamlining the processing of subsequently received content. Various embodiments contemplate sharing such databases for public service purposes such as eradicating universally objectionable content, and commercial purposes such as generating databases, hash tables, whitelist, blacklist and the like specifically constructed to reflect brand safety concerns of one or more brands or brand types. Further, access to these databases, hash tables, whitelist, blacklist and the like may also be included within the programmatic advertising transaction process as an add-on brand safety feature.

The various embodiments described herein contemplate the processing of one or more types of information associated with a content asset to determine whether that content asset is associated with objectively or subjectively objectionable content such that an advertisement should not be placed or presented adjacent the content. The amount of processing necessary to reach such a determination depends in part upon the type of information extracted from the content assets for processing, whether that information type requires intermediate processing steps and the like. As noted with respect to, illustratively, FIG. 4, text information, audio information, still/moving image information and the like may be extracted from a content asset and examined to identify data indicative of objectionable content, data indicative of not objectionable content and neutral data. Such data may comprise the source of the content, metadata associate of the content, language extracted from audio tracks, images extracted from video tracks and the like. Each of these different types of information requires different processing techniques and some of these processing techniques take longer than others to reach a result that is sufficiently accurate or of high enough confidence.

As noted above, medium confidence indication of factors driving a decision to place or not place an advertisement are perfectly adequate within the context of a timing loop which is ultimately linked to quality of user experience. In essence, various embodiments are configured to extract and process information from a user request the content asset to achieve a sufficient accuracy or confidence level or correlation to relevant brand criteria to make a decision about advertising placement. The decision may be wrong for a first user requesting that content, or even a first group of users requesting the content. However, the content is continually processed so that subsequent user request for such content may be more rapidly evaluated in view of proposed advertisements to be placed adjacent the content viewed by those subsequent users.

As an example, if the content asset has had extracted therefrom text information having a medium confidence correlation (e.g., 30%, 40%, 50%, 60% or whatever correlation percentage, whether low, medium or high, is deemed appropriate by an advertiser or brand) to text-based criteria associated with objectionable content for an advertiser then a medium confidence decision may be made that the advertisement should not be placed adjacent that content. Further, the extracted text information may also be weighted such as increasing the correlative weight of content sources known to provide objectionable content (e.g., pornographic websites, jihadi or militant websites, foreign propaganda websites and the like), descriptive terms known to relate to objectionable content (e.g., profanity, sexual language, militant language, selected foreign languages and the like) and so on. In addition to text-based correlation, audio information, still image information, moving image information and the like, or portions thereof, may be correlated to like media to rapidly identify suspected objectionable content. Various artificial intelligence techniques/mechanisms may be employed to perform the various steps and processes.

Advantageously, various embodiments operate to quickly provide a brand safety decisions pertaining to placing an advertisement next to content to be presented to a user. The decision may comprise placing an initial advertisement next to the content, placing a secondary or tertiary advertisement next to the content or placing now advertisement next to the content. Generally speaking, some content is deemed to be universally objectionable such that no advertisement should be associated with it. In this case, an advertisement URL associated with a blank advertisement may be transmitted to the SSP. Some content is deemed to be objectionable to the values of a particular brand or its corporate owners such that at least certain advertisement associated with the brand or its corporate owners should not be displayed next to such content. Decision may be made quickly where the content is deemed to be objectionable

In various embodiments, a stand-alone placement decision tool is provided wherein, in response to an input comprising a content URL (i.e., a URL pointing to content to be presented to a user) an advertising URL (i.e., a URL pointing to an ad to be presented/placed adjacent to the content, such as on the same displayed web page) and criteria indicative information (e.g., advertiser, brand, campaign identifier, hash table identifier and the like), various processes such as describe above are performed to produce as an output a place/no-place decision indication.

In various embodiments, a stand-alone content processing tool (optionally used with a stand-alone or integrated placement decision tool) is provided for processing content to extract characterizing data therefrom and assign a unique identification number to the content based on Photo DNA or other content processing methodologies.

In various embodiments, an integrated placement decision tool is provided such that the place/no-place decision may be integrated into or hooked into (e.g., such as via an applications programming interface (API), framework or other mechanism) a platform to enable TE control/automation of the place/no-place decision.

In various embodiments, a Placement Decision Console (PDC) is provided to enable real time viewing/tracking of placement decisions and historical reconstruction of non-decision impact such as identifying placements avoided, potential or actual bad placements and an indication of user response or other results, other monitoring activities and the like. The PDC enables advertiser or their agencies to determine what ads have been “not placed” or “placed” and where/when did this happened, the ratio/cost of place/no-place decisions and so on. It is contemplated that the PDC utilizes marketing services descriptions to include showing of place/no-place decisions according to one or more of the following criteria: Timestamp; User/Viewer; Ad; Adjacent content; Mode (web, mobile web, access network, MSO); Prior page/channel viewed by user; Next page/channel selected by user; Other information; Current/live activity; Prior/Historical Activity (i.e., pre-decision data for bad adjacencies that occurred so the trust engine can gauge reaction) and/or other criteria/parameters of interest.

In various embodiments, an Integrated Content Processing (ICP) tool is provided for interacting with publishers, content management platforms and the like such that content may be received/processed prior to, or contemporaneously with, the distribution/publishing of content (i.e., not related to a particular placement decision).

In various embodiments, a Stand-Alone or Integrated ad processing tool for processing advertisements and ancillary advertiser provided information (e.g., target audiences, relevant community standards, corporate mission, PR goals and the like) to extract characterizing data therefrom and assigning a unique identification number to the content based on Photo DNA or other processing of the content.

In various embodiments, advertisements are processed or otherwise caused (e.g., via agreements with advertisers or ad server entities) to include consumer feedback hooks for insertion into ads served to elicit thereby a consumer/user response to a question/query, such as:
“Does this ad belong with this content” (y/n)
“This ad should not follow me across the Internet because I . . . ” <“am out of the market”>; <“already bought product”>; <“bought other product”>; <“Other Reason”>

Various embodiments contemplate multiple phases of AI training, using multiple training and live data sets, to sufficiently accurately characterize advertising, brand equity, target market, market sensibilities/drivers and/or various criteria/parameters such as Company/brand level criteria, Product level criteria and the like. Further training of the advertising related AI is adapted to extracting data within the advertising creative/branding process suitable for use in automating the ad characterizing data and therefore improving the precision of ad creation, targeting and place/no-place decisions. Further training of the AI provides a mechanism to efficiently and accurately characterize content in manner consistent with ad characterizing (e.g., to allow fast hashing and placement decisions). Other embodiments are also contemplated by the inventors.

The various embodiments discussed above with respect to the figures contemplate a number of different mechanisms by which to achieve the goals of placing or not placing advertising for display next to content deemed subjectively (e.g., from a brand perspective, corporate perspective and the like) of objectively objectionable.

One embodiment comprises a method, apparatus, computer readable medium, computer program product and/or other mechanism for determining whether to present an advertisement contemporaneously with a presentation of user requested content at a user device, comprising: receiving, at an advertisement placement apparatus, a Uniform Resource Locator (URL) associated with a user requested content asset; retrieving the user requested content asset via the respective URL; processing the retrieved content asset in accordance with a content identification mechanism to generate thereby a content identifier associated with the requested user content; comparing the generated content identifier to one or more lists of content identifiers associated with content categorized in accordance with criteria associated with the proposed advertisement; in response to the generated content identifier being included in a list of content identifiers associated with non-objectionable content, transmitting a message indicating that the proposed advertisement may be presented with the user requested content; in response the generated content identifier being included in a list of content identifiers associated with objectionable content, transmitting a message indicating that the proposed advertisement should not be presented with the user requested content; in response to the generated content identifier not being included in the non-objectionable content list or the objectionable content list, initiating a text-based correlation process to correlate text-based information extracted from the retrieved content asset with text-based content criteria associated with the proposed advertisement; in response to a medium confidence correlation indicative of the user requested content comprising objectionable content, adding the generated content identifier to the objectionable content list and transmitting a message indicating that the proposed advertisement should not be presented with the user requested content; in response to a medium confidence correlation indicative of the user requested content comprising non-objectionable content, adding the generated content identifier to the non-objectionable content list and transmitting a message indicating that the proposed advertisement may be presented with the user requested content.

The above embodiments may be modified by, in response to the text-based correlation process failing to achieve a medium confidence correlation within a predefined period of time, transmitting a message indicating that the proposed advertisement should not be presented with the user requested content.

The above embodiments may be modified by, in response to the text-based correlation process failing to achieve a medium confidence correlation within a predefined period of time, transmitting a message indicating that the proposed advertisement may be presented with the user requested content.

The above embodiments may be modified by, in response to a high confidence correlation indicative of the user requested content comprising objectionable content, adding the generated content identifier to the objectionable content list and terminating the text-based correlation process.

The above embodiments may be modified by, in response to a high confidence correlation indicative of the user requested content comprising non-objectionable content, adding the generated content identifier to the non-objectionable content list and terminating the text-based correlation process.

The above embodiments may be modified by, in response to the text-based correlation failing to achieve a high confidence correlation within a second predefined period of time, initiating a non-text correlating process to correlate non-text-based information extracted from the retrieved content asset with non-text-based content criteria associated with the proposed advertisement.

The above embodiments may be modified in that the predefined identification mechanism comprises a sampling mechanism configured so extract from the content a plurality of predefined data elements and arrange the extracted data elements in a predefined manner to provide thereby the content identifier.

The above embodiments may be modified by, comparing the generated content identifier to one or more lists of categorized content identifiers comprises hashing the content identifier to respective one or more hash tables formed using categorized content identifiers.

The above embodiments may be modified in that the hash tables are generated in accordance with brand specific placement criteria.

### Suitability Database/Model

Suitability or appropriateness of content/media with respect to a particular advertisement placement for an particular advertiser or brand may be determined using various techniques such as discussed herein. Additional techniques may comprise the creations and utilization of a database or machine learning generated model of prior content deemed to be appropriate (whether or not advertisements were placed against the content).

In various embodiments, each of the steps 420-450 discussed above with respect to the method 400 of FIG. 4 further includes an optional step of updating a database or machine learning model of content suitability; that is, a database or model useful tracking content suitability decisions made with respect to various advertisement placements so as to further refine the placement decision making process, enable tracking of advertising campaigns/expenditures, monitor changes in affinity or trends in terms of content suitability over time, and so on. The content suitability database or model may be updated to reflect additional information tending to indicate that various content is suitable, not suitable (or trending toward being suitable or not suitable) in terms of presentation with particular advertising or branding of interest. Further, the strength of the suitability (e.g., the amount of alignment or correlation of the evaluated content with respect to the advertising may also be used to update the content suitability database or model.

In various embodiments, each of the steps 440-450 discussed above with respect to the method 400 of FIG. 4 further includes an optional step of evaluating (or further evaluating) the content using the content suitability database or model.

As content is evaluated from a larger potential perceived issue from meta data, the resolved database will contain elements that can indicate a potential problem ahead of a brand safety emergency. Metadata developed for or added to the content suitability database or model may be useful in identifying content associated with deepfake, misrepresentation, errors, undesirable sources and so on.

User created content that has not been vetted can represent unknown risks advertisers, and such risk may be mitigated by analyzing content related information such as URLs and various content components for possible indications of data manipulation within a multi layered interactive experience. Evaluation may be via analysis of the entirety of a content asset or portions thereof (e.g., individual frames or video segments).

Pattern recognition performed using the content suitability database or model may assist in identifying content being processed as similar to prior content associated with deepfake, misrepresentation, errors, undesirable sources and so on. In this manner, an additional decision support layer may be provided to enable a “do not place advertising” decision, or at least a “suspend advertising placement” decision.

The content suitability database or model provides additional means of not only improving advertisement placement decisions, but also identifying and tracking corresponding decision history, trends in decision outcomes or identification of problematic content, and so on. Determination of averted (or allowed) content/advertising adjacencies during user presentation also help identify specific consumer problems that may arise so as to allow a brand safety response to a problem while the problem is manageable.

### Further Realizations and Refinements

As depicted and described above, various embodiments may be provided to address the advertising adjacency problem (i.e., placing advertising for a brand adjacent content that is objectively or subjectively objectionable) by contextually understanding content to be served to a requesting user, determining if that contextual understanding is compatible with brand affinity, and choosing not to place advertising adjacent to the content where a contextual understanding of the content indicates an incompatibility of the content with brand goals/messaging.

### Adjacency Processing With Place/No-Place Decision

Various embodiments provide systems, methods, architectures, mechanisms, apparatus or protocols configured to determine whether to present an advertisement contemporaneously with a presentation of user requested content at a user device by (for each opportunity to place an advert adjacent a called content asset such as web page URL), such as in accordance with the following process flow (after building initial brand affinity decision structures, such as criterion-focused hash tables and the like):
At RTB Pre-Bid (best) or Post-Bid, identify source user requested content and acquire user requested content asset(s)
Perform content asset fingerprinting of requested user content asset(s)
Perform contextual content processing (if needed—may have been processed previously)
Perform brand affinity correlation to multiple criteria
Determine Place/No-Place Decision based on multiple affinity correlation scores
   If Place, then inject advertising asset(s) for presentation with user requested content
   If No-Place, then:
      (1) inject nothing (blank presentation);
      (2) inject alternate advertising asset(s); or
      (3) invoke rebid/secondary market process (very short time frame)

Generally speaking, the Trust Engine Platform 200 is computer implemented as described above with respect to the various figures. The platform 200 may be a stand-alone entity configured to perform the various functions described herein, or it may be integrated into one or more of the other platforms/entities within the relevant environment. For example, the various processing and control functions may include some or all of the following functional modules, which modules may be implemented via the computer machinery described herein. Various embodiments implement a Software as a Service (SaaS) platform enabling direct interaction by users (e.g., advertisers, agencies, and the like) initiating and/or maintaining advertising campaigns.

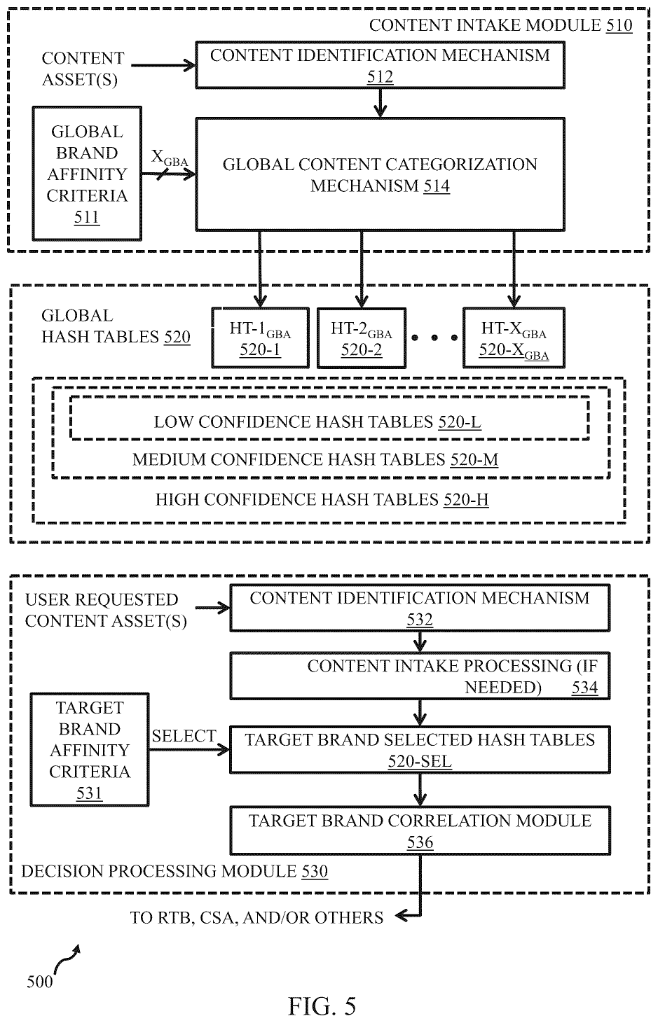

FIG. 5 depicts a flow diagram of a content processing method according to various embodiments. Specifically, FIG. 5 depicts a system/method 500 further detailing exemplary processing entities associated with a content intake module 510, a set of global hash tables 520, and a decision processing module 530. The methods and systems of FIG. 5 in some embodiments are similar to those described above with respect to FIG. 4 and the various other figures, with various improvements and additional features therefrom.

As depicted in FIG. 5, the content intake module 510 is configured to receive content assets and, using a global content categorization mechanism 514, categorize the received content assets in accordance with global brand affinity criteria 511. The global brand affinity criteria 511 comprises numerous criteria related in some way to brand affinity such as defined by the brands themselves. As depicted herein, the global brand affinity criteria 511 includes all brand criteria of all brands utilizing the various systems, as well as additional criteria and derivative criteria. The global brand affinity criteria 511 comprises a large number “XGBA” of differing criteria which may be used within the context of categorizing content such as discussed above. It is contemplated that a target brand will not use all of the global brand criteria 511 in making determinations as whether to place or not place advertising next to specific content since at least some of the global brand criteria 511 may be irrelevant to the target brand, or inherently conflicting with other criteria within the global brand criteria 511 (e.g., two criterion for the same brand affinity concept but stated in opposite or different language), and so on.

As depicted in FIG. 5, the global content categorization mechanism 514 categorizes received content by including the content identifier (e.g., digital fingerprint) of the received content in those hash tables 520 associated with global affinity criteria met by (correlated to) the received content.

In some embodiments, one hash table 520 is used for each of the global affinity criteria, such as hash tables HT-1GBA, HT-1GBA, and so on through HT-XGBA (denoted in FIG. 5 as hash tables 520-1 through 520-XGBA).

In some embodiments, two or more hash tables are used for each of the global affinity criteria, such as the low confidence hash tables 520-L, medium confidence hash tables 520-M, and/or high confidence hash tables 520-H. In these example, the terms low, medium, and high may be defined in terms of correlation to a particular global brand affinity criteria.

As depicted in FIG. 5, the decision processing module 530 is configured to receive content assets such as user requested content assets and identify the content assets using a content identification mechanism 532 that operates in substantially the same manner as the content identification mechanism 512 of the content intake module 510.

The content identifier (e.g., digital fingerprint) of the received user requested content is hashed into target brand selected hash tables 520-SEL to identify those hash tables (i.e., those positive and/or negative brand affinity correlations) associated with the user requested content such that a target brand correlation module 536 may determine whether the user requested content assets are sufficiently or appropriately aligned with the target brand affinity criteria (TBAC) and, therefore, a place or no-place decision is made about injecting content assets for presentation (advertising) against the user requested content. That is, the target brand correlation module 536 generates a control signal indicative of whether the user requested content is sufficiently aligned with the TBAC, the control signal being configured to cause, via any of several mechanisms discussed herein and above, a modification of the presentation of an advertising asset to the requesting user. That is, the control signal may operate as a pass/fail flag suitable for use in determining whether to associate an advertising asset with a content asset for presentation to a user. For example, the control signal may be used as, or to trigger, any of a URL_fail flag, URL_pass flag, CONTENT_fail flag, CONTENT_pass flag, TEXT_fail flag, TEXT_pass flag, COMPATIBLE_fail flag, COMPATIBLE_pass flag, and/or other mechanisms discussed above with respect to FIG. 4 and other figures which, when activated or invoked, operate to enable the presentation of advertising content to the user or prevent such presentation.

In various embodiments, the TBAC may be updated via a remotely located advertiser, such as in response to changes in advertising campaign parameters, updates to advertising efficacy metrics indicative of a beneficial change, and so on.

The target brand selected hash tables 520-SEL comprise a subset of the global hash tables 520 generated by the content intake module 510, which subset is selected via a selection mechanism SELECT driven by target brand affinity criteria 531.

In some embodiments, one hash table is used for each of the global target brand affinity criteria. In some embodiments, multiple hash tables are used for each of the global target brand affinity criteria.

To simplify processing by allowing for quicker convergence to a decision, the selected hash tables 520-SEL may be processed in order of importance or decision weight such that sufficient positive or negative correlation between the user requested content and the target brand affinity may be more quickly (efficiently) realized.

If the user requested content has not previously been categorized, then the associated content assets are subjected to full (global) categorization such as using the global content categorization mechanism 514 of the content intake module 510. Alternatively, the associated content assets are subjected to partial categorization, such as using only the target brand affinity criteria 531 rather than the global brand affinity criteria 511. In various embodiments, after this partial categorization a first process or thread continues to perform categorization of the user selected content assets for the remainder of the global brand affinity criteria 511, while a second process or thread performs the target brand correlation process 536.

Single Positive Correlation Embodiments. In these embodiments, each of the 1000 global brand affinity criteria is associated with a single hash table. For these embodiments, content is processed by the content intake module 510 against each of the 1000 criteria for categorization thereby, and the content ID of content positively correlating to any of the 1000 global brand affinity criteria is hashed into the respective positive correlation hash table thereof. In these embodiments, the decision processing module 530 compares the content ID of user selected content to some or all of the (illustratively) 50 positive correlation hash tables to generate thereby decision related data (e.g., place/no-place, place alternate ad, place blank ad, ignore opportunity to place, resell placement on secondary RTB market, and so on.)

Single Negative Correlation Embodiments. In these embodiments, each of the 1000 global brand affinity criteria is associated with a single hash table. For these embodiments, content is processed by the content intake module 510 against each of the 1000 criteria for categorization thereby, and the content ID of content negatively correlating to any of the 1000 global brand affinity criteria is hashed into the respective negative correlation hash table thereof.

Multiple Positive Correlation Embodiments. In these embodiments, each of the 1000 global brand affinity criteria is associated with, illustratively, three hash tables (though more or fewer may be used depending on the number confidence levels deemed useful). For these embodiments, content is processed by the content intake module 510 against each of the 1000 criteria for categorization thereby at each of three confidence levels of such positive correlation, and the content ID of content positively correlating to any of the 1000 global brand affinity criteria is hashed into the respective positive correlation hash table(s) thereof.

Multiple Negative Correlation Embodiments. In these embodiments, each of the 1000 global brand affinity criteria is associated with, illustratively, three hash tables (though more or fewer may be used depending on the number confidence levels deemed useful). For these embodiments, content is processed by the content intake module 510 against each of the 1000 criteria for categorization thereby at each of three confidence levels of such negative correlation, and the content ID of content negatively correlating to any of the 1000 global brand affinity criteria is hashed into the respective negative correlation hash table(s) thereof.

In an example, a system according to various embodiments may contemplate 1000 global brand affinity criteria 511 to which a content asset may positively correlate and/or negatively correlate (e.g., correlation above a particular threshold confidence level, such as 80%). Additionally, each of the positive and negative correlations may be of low, medium or high confidence, such as 20%, 50%, and 80% respectively). Assume that particular brand is concerned about only a subset of the 1000 criteria, illustratively 50 of the criteria.

It is noted that new content may be processed by the content intake module 510 against all of the global brand affinity criteria 511, however user requested content is processed by the decision processing module 530 against only the target brand affinity criteria 531. In particular, only by comparing the content ID of the user requested content to the relevant hash tables associated with that target brand affinity criteria 531.

In this example, where 50 target brand affinity criteria 531 are of interest, each of those 50 target brand affinity criteria 531 may be associated with one or more hash tables to enable such processing. Inclusion of the content ID in such a hash table indicates correlation of the identified content to the target brand affinity criterion 531 of that hash table 520 above some confidence level (e.g., 50%, 80%, 90%, or some other level).

Therefore, the decision processing module 530 may need to hash the content ID of user requested content into up to 50 hash tables until sufficient characterization of the user content is achieved to trigger a decision mechanism.

Further, since the each of the target brand affinity criteria 531 is of differing importance to the brand, the processing of the target brand affinity criteria 531 via the content ID hashing into the relevant hash tables is preferably performed in a prioritized manner reflecting such differences in importance.

Therefore, by prioritizing the order of processing, the decision processing module 530 will need to hash the content ID of user requested content into fewer than 50 hash tables until sufficient characterization of the user content is achieved to trigger a decision mechanism.

Further, since the target brand affinity criteria 531 may include both brand positive criteria and brand negative criteria, the processing of the target brand affinity criteria 531 via the content ID hashing into the relevant hash tables is preferably performed against both positive correlation and negative correlation hash tables as appropriate. Thus, in various embodiments both negative and positive correlation hash tables may be used for correlating user content ID to target brand affinity criteria 531.

Therefore, the decision processing module 530 may need to hash the content ID of user requested content into up to 100 hash tables until sufficient characterization of the user content is achieved to trigger a decision mechanism. However, since it is highly unlikely for content to be included in both positive and negative hash tables of the same target brand affinity criteria 531, less than 100 processing operations will likely be needed to achieve sufficient characterization of the user content is achieved to trigger a decision mechanism Further, by prioritizing the order of processing the number of necessary processing operations will be further reduced.

Further, since different confidence levels of correlation may be realized based on incomplete information or uncertainties within the new content intake process, each of the positive and negative correlations may be associated with multiple confidence levels, illustratively three confidence levels (low, medium, and high) though more or fewer may be used. Thus, each of the positive and negative correlations may be of low, medium or high confidence, such as 20%, 50%, and 80% respectively.

Therefore, the decision processing module 530 may need to hash the content ID of user requested content into up to 600 hash tables until sufficient characterization of the user content is achieved to trigger a decision mechanism. However, since it is highly unlikely for content to be included in both positive and negative hash tables of the same target brand affinity criteria 531, less than 600 processing operations will likely be needed to achieve sufficient characterization of the user content is achieved to trigger a decision mechanism Further, by prioritizing the order of processing the number of necessary processing operations will be further reduced.

### Compound Brand Affinity Criteria

In various embodiments, the systems, apparatus, and methods described above provide for the processing of content assets (video, audio, still images, documents, and so on of whatever format) in accordance with a large number of different types of brand affinity criteria denoted herein as global brand affinity criteria. Global brand affinity criteria may include single criteria or compound criteria, wherein compound brand affinity criteria comprises a combination or accumulation of multiple individual brand affinity criteria such that content that correlates 100% with a compound brand affinity criteria may be considered as correlating 100% with each of the individual brand affinity criteria used to define the compound brand affinity criteria. Compound brand affinity criteria may also be defined in a negative sense, wherein a combination or accumulation of multiple individual negative brand affinity criteria such that content that correlates 100% with a negative compound brand affinity criteria may be considered as correlating 100% with each of the individual negative brand affinity criteria used to define the compound negative brand affinity criteria.

Thus, the various processing steps of the elements described above in the various figures may be adapted such that, in addition transmitting a message indicating that a proposed advertisement may have low, medium, or high correlation with content criteria associated with a proposed advertisement (e.g., as part of a place or do-no-place decision), the content suitability database or model may also be updated in accordance with the proposed advertisement, the identified content, the correlation, and any other data such as associated with the content, the advertisement, or the transmitted message.

Various embodiments provide additional modifications and/or improvements to the above, as discussed below.

### Content Intake/Processing Module(s)

On-the-fly: Responsive to RTB purchase of advertising right to a user presentation of user requested content (URC), processing retrieved content asset(s) if not already known/processed in accordance with:
   Content identification mechanism to generate thereby a content identifier associated with the requested user content (meta data, digital fingerprint/Hany Farid type processing etc.) that is suitable for use in a high speed processing/comparison regime. Hash tables are one example, other types of processing may be used.
   Content categorization mechanism to process the content such as via a text-based correlation process to categorize content according to:
      (1) affinity of the content with respect to each of a number of brand-relevant criteria (including specific criteria important to a particular brand); and
      (2) confidence level of the determined affinity.
   For example, assuming 100 criterion of varying importance to a brand, individual hash tables may be constructed for each of those 100 criteria, possibly including specific high, medium, and low confidence level tables. Text-based correlation process may use any CC data, meta data, voice recognition data, optical recognition data and so on derived from the content or its container to provide raw text or narrative for processing by natural language and/or other tools.
Purposeful or Pre-Processing: Same as above but performed at content ingestion stage with cooperating content publishers.

### Place/No-Place Decision Processing Module(s)

Place/No-Place decision mechanism to process the URC against the relevant content affinity hash tables. In the example, while providing 300 tables in total, not all of these need to be processed if the processing sequence is intelligently selected. Therefore, affinity criteria processing should be stacked/staged with a view toward brand alignment concerns/objectives so as to prioritize processing of most important positive and negative criteria first.

### Capture and Store for Audit Processing Module(s)

Capture/Store for Audit (CSA) for each advertiser: Advertising asset ID for all placed adverts, Content asset ID non-placement ads as well as adjacent placed ads, time of ad placement, platform of ad/content presentation, presentation details (page location, size, duration of view, etc.), related tracking data as appropriate/allowed, and so on. CSA is discussed above with respect to the various steps of FIG. 4, wherein the databases and ML models are optionally updated to store the processing input/output of some or all of steps 420-450.
   CSA is a separate product/service: CSA may be used with or without advert place/no-place decision processing within RTB process. Different levels of CSA may be provided, such as:
      Full CSA with adjacency processing/decision: Adjacency processing with place/no-place decisions, plus CSA. Capture and Store maximum number of ad placement representative data elements.
      Full CSA without adjacency processing/decision: No adjacency processing. Capture and Store maximum number of ad placement representative data elements except those pertaining to Adjacency processing (e.g., content asset fingerprinting, contextual content processing, brand affinity correlation, decision engine, placement (inject advertising asset), invoke no-placement (inject nothing—blank presentation), invoke alternate placement (inject alternative advertising asset(s)).
      Partial CSA with adjacency processing/decision:
      Partial CSA without adjacency processing/decision:
   Validation/Verification:
Improve the fidelity/accuracy of the captured/stored data so as to improve confidence level of advertisers when provided with statistics about their campaigns so they can properly assess impact/value and make informed advertising decisions going forward.
   Asset ID: To ensure valid ad was placed and correct content was adjacent to valid ad, we associated content identifier (fingerprint) with each advertising/content asset. This can be simple or more detailed (i.e., computational/memory intensive). Need to determine happy medium: What is sufficient to get the job done acceptably, not perfectly?
   Asset Fidelity/Validity: To ensure that content asset is not altered/modified in any way (e.g., video frames dropped, resolution reduced, fake ad substituted or embedded within, etc.) the fidelity of the ad may be assessed and scored (Attestiv type processing). This can occur at several points in the ad placement process and on different platforms.
   Asset Tracking: Tracking data indicative of the valid ad being placed against the correct and valid content on a particular platform at a particular time and to a particular (anonymized?) user. Reassessment of content/advertising asset validity may be performed at multiple locations within the processing/delivery chain so as to identify locations within this chain where assets are manipulated/replace.
      Use of light-processing blockchain to record and maintain initial and subsequent validity assessment results, along with routing information to confirm that assessment locations and so on are valid may be provided.
      Important to avoid overly burdensome process, since number of asset validity assessments will be huge.

### Invalid Traffic Processing/Retention With CSA

In various embodiments, the systems, apparatus, and methods described herein incorporates Invalid Traffic (IVT) metrics/indicators into CSA (capture this information and store it for auditing and other purposes), such as generated using the techniques/processes discussed in the “Invalid Traffic Detection and Filtration Standards Addendum” of Jun. 25, 2020, which in section 1.1.2 defines IVT via two categories as follows:
1. “General Invalid Traffic” or GIVT, consists of traffic identified through routine means of filtration executed through application of lists or with other standardized parameter checks. Key examples are:
   Known invalid data-center traffic (determined to be a consistent source of invalid traffic; not including routing artifacts of legitimate users or virtual machine legitimate browsing);
   Bots and spiders or other crawlers (except those as noted below in the “Sophisticated Invalid Traffic” category);
   Activity-based filtration using transaction-level data and parameters from campaign or application data;
   Non-browser user-agent headers or other forms of unknown browsers;
   Pre-fetch or browser pre-rendered traffic (where associated ads were not subsequently accessed by a valid user; note: updated IAB/MRC Measurement Guidelines require an ad to have loaded and begun to render in order to record an impression; as a result, pre-fetch or pre-rendered traffic shall not be included in Gross impression counts);
   Invalid placements (specific to ads); small, barely visible or invisible ad delivery or illogical (non-industry standard) ad size of: 0×0 and 1×1 as delivered on the client side (Note: When using declared ad sizes, efforts should be made to determine whether bid request declarations are for request purposes only or represent actual placement size); and
   Non-rendering capabilities; sessions or traffic without the capability to render or display images (other than cases of disabled image rendering) as determined at the client side even though rendered impressions or other activity may be associated with them such as headless browsers or component devices without a display component.
2. “Sophisticated Invalid Traffic” or SIVT, consists of more difficult to detect situations that require advanced analytics, multi-point corroboration/coordination, significant human intervention, etc., to analyze and identify. Exemplary examples include:
   Automated browsing from a dedicated device: Known automation systems (e.g., monitoring/testing), emulators, custom automation software and tools;
   Automated browsing from a non-dedicated device: infected and hijacked devices (and sessions within) as well as incentivized automated activity;
   Incentivized human invalid activity (e.g., click farms where non-robotic activity can be determined to be organized and directed across multiple users or machines, etc.): self-directed activity to benefit self or harm others and directed activity;
   Manipulated activity: Forced new browser window opening, forced tab opening, forced mobile application install (mobile re-direct), forced clicking behavior, tricking users to click/accidental clicks, clickjacking (UI redress attack) and hijacked measurement events;
   Falsified measurement events: visit, impression, viewability, click, location (specific to location falsification aimed at generating invalid ad activity, but not necessarily including validation of exact location for targeting purposes), referrer, consent string, conversion attribution and user attribute spoofing as well as Server Side Ad Insertion (SSAI) spoofing where applicable to a measurement organization;
   Domain and App misrepresentation: App ID spoofing, domain laundering and falsified domain/site location;
   Bots and spiders or other crawlers masquerading as legitimate users detected via sophisticated means;
   Hijacked ad tags and creatives (specific to ads);
   Hidden/stacked/covered/transparent/invisible or otherwise intentionally obfuscated ad serving such as Z-order stacking, banner stuffing, transparent ads and background cycling and pop-under with auto-close (specific to ads);
   Invalid proxy traffic (originating from an intermediary proxy device that exists to manipulate traffic counts or create/pass-on invalid traffic or otherwise failing to meet protocol validation);
   Adware and Malware that conduct deceptive actions including ad injection and unauthorized overlays;
   Incentivized manipulation of measurement (invalid incentivized promotion of an entity, without its knowledge or permission such as shilling or for purposes of manipulating measurement—excludes cases where the entity paying for the incentive is the entity being promoted);
   Misappropriated (pirated or stolen) content (where used to purposefully falsify traffic at a material level);
   Cookie stuffing, recycling or harvesting (inserting, deleting or misattributing cookies thereby manipulating or falsifying prior activity of users); and
   Differentiating valid and IVT traffic when originating from the same or similar source in certain closely intermingled circumstances.

The term IVT refers to both GIVT and SIVT collectively. Specific aspects of GIVT and SIVT procedures will be described in more detail below. It is expected that, over time, items that are currently included in the definition of SIVT may be incorporated into standardized, objective lists and criteria through industry organizations and, as a result, may be re-categorized as GIVT.

The various embodiments described above provide a technical solution to the problem of brand alignment with advertisement placement in view of adjacent content, among other advantages. The content adjacent to the advertising may be video, audio, text, and/or combinations thereof such as social media posts, YouTube video channels, and so on. The advertiser-focused embodiments enable advertisers to make informed and substantially real-time decisions regarding the type of advertising (if any) that they should place with respect to the content selected by the user to whom advertising may be served (i.e., presented adjacent the selected content, such as imbedded in a web page being viewed by the user). The various embodiments are suitable for use within the context of both linear and non-linear content distribution and/or presentations systems, CTV, and so on.

Generally speaking, various embodiments of a system for augmenting decision making processes and (optionally) capturing for audit the actions resulting from those decisions, comprises various functional elements/modules configured to perform tasks such as:
(1) Correlates different types of content to each of a large number of “global” brand-related criteria;
(2) Maps advertisers' brand/advertising affinity/goals to the global brand-related criteria to select advertiser specific brand-related criteria;
(3) Uses the advertiser specific brand-related criteria to process content associated with an advertisement placement opportunity to determine whether/how to respond to the opportunity (e.g., RTB ad-buy); and
(4) Captures and Tracks for Audit all decisions and relevant data to enable tracking of process, campaign results, refinement of campaign, etc.

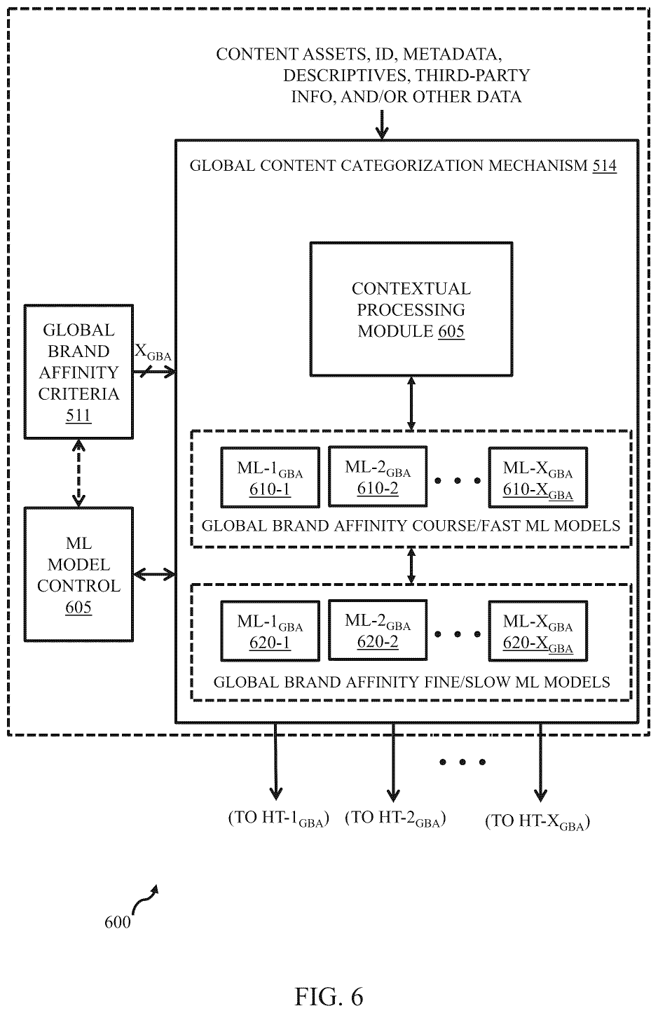

FIG. 6 depicts global content categorization mechanism suitable for use in the content processing methods/systems of the embodiments. As depicted in FIG. 6, the global content categorization mechanism 514 receives content assets and corresponding content ID (content asset ID), along with any metadata, descriptives (e.g., title, program guide blurb and the like), third-party information if any, and/or other data. In addition to various contextual processing modules 605 to extract from the received information as much contextual information as possible, including context changes as a function of time for video or audio content. The contextual processing of the contextual processing module 605 may be wholly or partially performed using data received from one or more remote context processing system (not shown) in communication with the contextual processing module 605.

In various embodiments, the output of the contextual processing module 605 is used to generate or assist in the generation of each of a plurality of models corresponding to the global brand affinity criteria 511.

As depicted in FIG. 6, a first or course processing set of machine learning (ML) models 610 (combined and/or one model for each or at least an important subset of the global brand affinity criteria 511) may be built/augmented by some or all of the contextual information associated with each processed content asset for various purposes, such as to normalize the contextual data associated with respective global brand affinity criteria 511.

Further, a second or fine processing set of machine learning models 610 (one model for each or at least an important subset of the global brand affinity criteria 511) may be built/augmented by some or all of the contextual information associated with each processed content asset for various purposes, such as to normalize the contextual data associated with respective global brand affinity criteria 511.

The ML models are configured in accordance with commands received from a ML model controller 605, which optionally communicates with the source of global brand affinity data 511 (e.g., an advertiser, ad agency and the like). This control loop and feedback process enables refinement of the ML models in response to external circumstances associated with particular decisions made within the context of the systems/methods described herein.

Various modifications may be made to the systems, methods, apparatus, mechanisms, techniques and portions thereof described herein with respect to the various figures, such modifications being contemplated as being within the scope of the invention. For example, while a specific order of steps or arrangement of functional elements is presented in the various embodiments described herein, various other orders/arrangements of steps or functional elements may be utilized within the context of the various embodiments. Further, while modifications to embodiments may be discussed individually, various embodiments may use multiple modifications contemporaneously or in sequence, compound modifications and the like.

Although various embodiments which incorporate the teachings of the present invention have been shown and described in detail herein, those skilled in the art can readily devise many other varied embodiments that still incorporate these teachings. Thus, while the foregoing is directed to various embodiments of the present invention, other and further embodiments of the invention may be devised without departing from the basic scope thereof. As such, the appropriate scope of the invention is to be determined according to the claims.

What is claimed is:

1. A computer implemented advertisement placement decision apparatus configured to operatively communicate with equipment within a programmatic advertising system to selectively modify presentation at a user device of advertising assets, the method comprising:
a content intake module configured for processing each received content asset to generate a respective content identifier, to categorize the content asset in accordance with medium confidence correlation to each of a plurality of global brand affinity criteria (GBAC), and to store the respective content identifier within a respective hash table of each medium confidence correlated GBAC; and
a decision processing module configured for processing each received user requested content asset to generate a respective content identifier, for determining whether the generated content identifier is associated with each of a subset of GBAC hash tables in accordance with target brand affinity criteria (TBAC), and to generate a control signal indicative of whether the user requested content is sufficiently aligned with the TBAC, the control signal being configured to cause a modification of the presentation of an advertising asset to the requesting user.

2. The computer implemented advertisement placement decision apparatus of claim 1, wherein:
the modification of the presentation of an advertising asset to the requesting user comprises preventing injection of an advertising content asset into a user presentation stream including the user requested content.

3. The computer implemented advertisement placement decision apparatus of claim 1, wherein:
the content intake module is further configured to categorize the content asset in accordance with high confidence correlation to each of the plurality of GBAC, and to store the respective content identifier within a respective hash table of each high confidence correlated GBAC.

4. The computer implemented advertisement placement decision apparatus of claim 3, wherein:
the content intake module is further configured to categorize the content asset in accordance with low confidence correlation to each of the plurality of GBAC, and to store the respective content identifier within a respective hash table of each low confidence correlated GBAC.

5. The computer implemented advertisement placement decision apparatus of claim 1, wherein:
the decision processing module is further configured for determining whether the generated content identifier is associated with each of the subset of GBAC hash tables in accordance with an order of importance of the TBAC, and to generate the control signal upon processing a number of GBAC hash tables sufficient to provide a positive or negative correlation between the user requested content and the target brand affinity.

6. The computer implemented advertisement placement decision apparatus of claim 5, wherein the control signal operates as a pass/fail flag suitable for use in determining whether to associate an advertising asset with a content asset for presentation to a user.

7. The computer implemented advertisement placement decision apparatus of claim 1, wherein the apparatus is operatively coupled to at least one of a DSP and an SSP.

8. The computer implemented advertisement placement decision apparatus of claim 1, wherein the TBAC may be updated via a remotely located advertiser.
